(19) United States
(12) Patent Application Publication
(10) Pub. No.: US 2011/0009784 A1
(43) Pub. Date: Jan. 13, 2011

(54) Compression device for medical treatment

(76) Inventors: Li-Ling Li, Tu-Cheng (TW); Yao-Ming Cheng, Tu-Cheng (TW); Ching-Liang Yu, Tu-Cheng (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,440

(22) Filed: Jul. 13, 2009

(51) Int. Cl. A61H 7/00

(52) U.S. Cl. 601/151

(57) ABSTRACT

A compression device for medical treatment includes an upper colloid sheet, a lower colloid sheet, and a plurality of gas ports. The upper colloid sheet is stacked with the lower colloid sheet and welded, so as to form a plurality of isolated cells with welded walls, and each cell respectively corresponds to one of the gas ports. Therein, the welded walls that neighbors each cell extend diagonally along an angle that is between an x-axis direction and an y-axis direction, so that the welded walls extends from an edge of the upper colloid sheet and the lower colloid sheet to another edge of the upper colloid sheet and the lower colloid sheet. Per aforementioned, the compression device for medical treatment has diagonally formed cells, which results in compression from two directions, so that the medical benefits are increased.

### BACKGROUND OF THE INVENTION

1. Field of the Invention

The present invention relates to a product for medical treatment; in particular to a compression device for medical treatment, which is used for compressing the limbs of a human body.

2. Description of Related Art

It has been shown that using compression/decompression in proper sequence on curing portions of the limbs of a human body has medical benefits. Therein, the compression/decompression generates a massaging effect and a pumping action within blood vessels and lymph nodes, which has beneficial effects for treating lymphatic disease, varicose vein, and chronic venous disease, and can prevent deep vein thrombosis (DVT).

As shown in FIG. 1, U.S. Pat. No. 6,010,471 disclosed a body treatment apparatus, which is formed by a plurality of continuous and serially connected sheets 11 that have a plurality of inflatable cells 111, wherein each sheet 11 is fitted with a gas port 12, so as to provide a way to inflate or deflate the inflatable cells 111. Furthermore the exterior of the sheet 11 is fitted with a fastening strip 13 such as Velcro.

As shown in FIG. 2, the aforementioned patent can be gradually wrapped around an arm of a human body in a spiraling way, and subsequently be fixed into position via the fastening strips 13 sticking to each other. Then the gas ports 12 are respectively connected to a gas tube, air may be introduced into each inflatable cell 111 via an air pump for compressing the arm, and thereby achieve the aforementioned effect of medical treatment.

However, the aforementioned patent design has the following drawbacks when being applied for operation:

1. Regarding technical proposal of wrapping in a spiraling way, due to the fact that patients have variations in body type, and the fact that the parts of the limbs closer to the body are thicker, once the wrapping has been completed, the locations of the gas ports may not be positioned in a organized fashion such as aligned vertically. The result is that the piping routes associated with the gas ports become disorderly and confused, subsequently increasing the preparation time for medical personal.

2. If the user is not a medical professional, the diagonal angle resulting from the wrapping may be hard to control precisely, therefore the resulting compression pressure may be uneven, leading to undesired effects.

3. Usage time associated with the apparatus is long, due to the technical proposal of wrapping in a diagonal way. For example if the gas tubes are attached to the gas ports in advance, then the gas tubes could impede the wrapping of the body treatment apparatus; yet if the gas tubes are attached after the wrapping, then this affects the preparation time with the patient, causing the operation time associated with the apparatus to extend, thereby making the patient impatient and annoyed.

As shown in FIG. 3 and FIG. 4, U.S. Pat. No. 6,846,295 disclosed a compression sleeve, which forms a plurality of inflatable cells 111a on two sheets 11, and thereby may be placed on a lower extremity of a human body for compressing the lower extremity.

However, the inflatable cells shown in U.S. Pat. No. 6,846,295 are formed horizontally. When the compression sleeve is in used, the compression sleeve just provides the force in single direction. Although the medical purpose is achieved, the medical effect of using the compression sleeve is inferior to the medical effect that the nursing staff presses diagonally from the bottom to the top. Therefore, the medical effect of using the compression sleeve is limited.

Consequently, because of the above limitations resulting from the technical design of the prior art, the inventor strives via real world experience and academic research to develop the present invention, which can effectively improve the limitations described above.

### SUMMARY OF THE INVENTION

An object of the present invention is to provide a compression device for medical treatment, which installs a plurality of diagonally formed cells, therefore is able to supply oblique radial force along with regular axial pressure force while providing compression, so as to increase the benefit for medical treatment.

In order to achieve the aforementioned objectives, a compression device for medical treatment is provided according to the present invention. The device includes an upper colloid sheet, a lower colloid sheet, and a plurality of gas ports. Therein, the upper colloid sheet is stacked with the lower colloid sheet and welded, so as to form a plurality of isolated cells with welded walls, and each cell respectively corresponds to one of the gas ports. Furthermore, the upper colloid sheet and the lower colloid sheet has an x-axis direction and a y-axis direction defined, and the welded walls that neighbors each cell extends diagonally along an angle that is between the x-axis direction and the y-axis direction, so that the welded walls extend from an edge of the upper colloid sheet and the lower colloid sheet to another edge of the upper colloid sheet and the lower colloid sheet.

Therefore through the aforementioned technical proposal of the present invention, the following efficacy is achieved: due to the upper colloid sheet and the lower colloid sheet forming a plurality of cells that extend in diagonal direction, while providing compression not only the regular axial pressure is generated, but also an oblique radial force, thereby achieving compression from two directions and thus increasing the benefit for medical treatment.

In order to further understand the characteristics and technical contents of the present invention, a detailed description relating thereto will be made with reference to the accompanying drawings. However, the drawings are illustrative only, and not intended to limit the scope of the present invention.

### BRIEF DESCRIPTION OF THE DRAWINGS

FIG. 1 is a perspective view showing a prior art body treatment device;

FIG. 2 is a schematic diagram showing the prior art body treatment device wrapped around an arm of a human body;

FIG. 3 is a planar view showing a prior art compression sleeve;

FIG. 4 is a schematic diagram showing the prior art compression sleeve wrapped around a leg of a human body;

FIG. 5 is a planar view (1^{st} planar view) showing a compression device for medical treatment in accordance with the present invention;

FIG. 6A is a sectional view (1^{st} sectional view) showing the compression device for medical treatment in accordance with the present invention;

FIG. 6B is a sectional view (2^{nd} sectional view) showing the compression device for medical treatment in accordance with the present invention;

FIG. 6C is a perspective sectional view showing the compression device for medical treatment in accordance with the present invention;

FIG. 7 is a schematic diagram showing the compression device for medical treatment wrapped around an arm of a human body in accordance with the present invention;

FIG. 8 is a sectional view (3^{rd} sectional view) showing the compression device for medical treatment in accordance with the present invention;

FIG. 9 is a planar view (2^{nd} planar view) showing the compression device for medical treatment in accordance with the present invention;

FIG. 10 is a schematic diagram showing the compression device for medical treatment wrapped around a leg and thenar of a human body in accordance with the present invention;

FIG. 11 is a planar view (3^{rd} planar view) showing the compression device for medical treatment in accordance with the present invention; and

FIG. 12 is a sectional view (4^{th} sectional view) showing the compression device for medical treatment in accordance with the present invention.

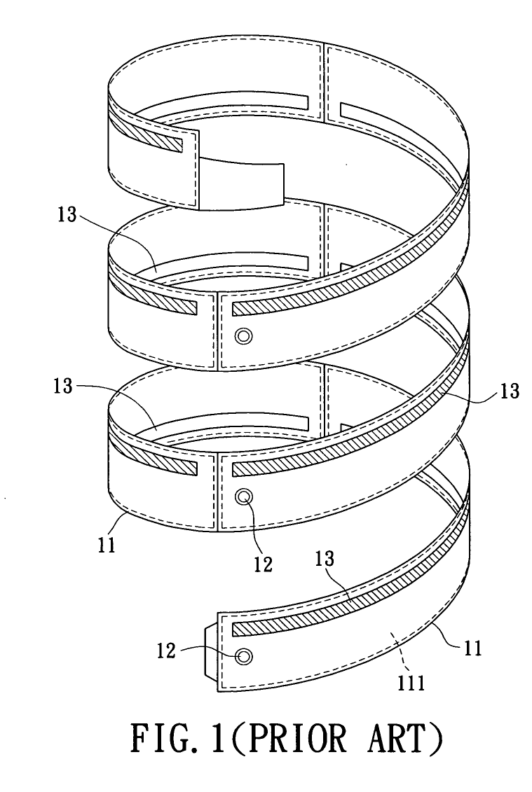

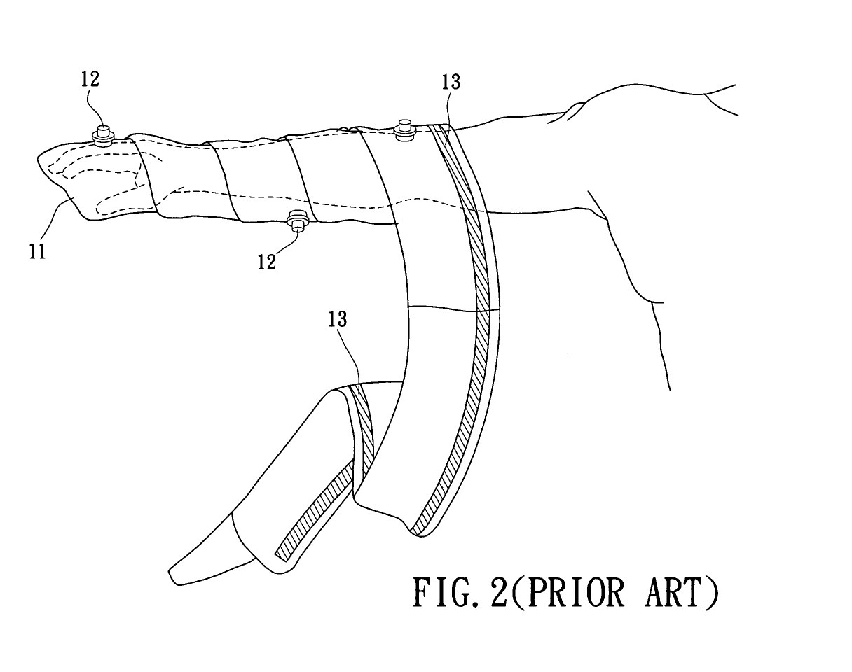

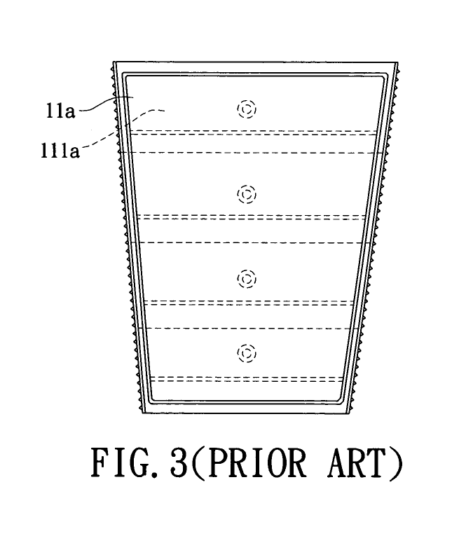

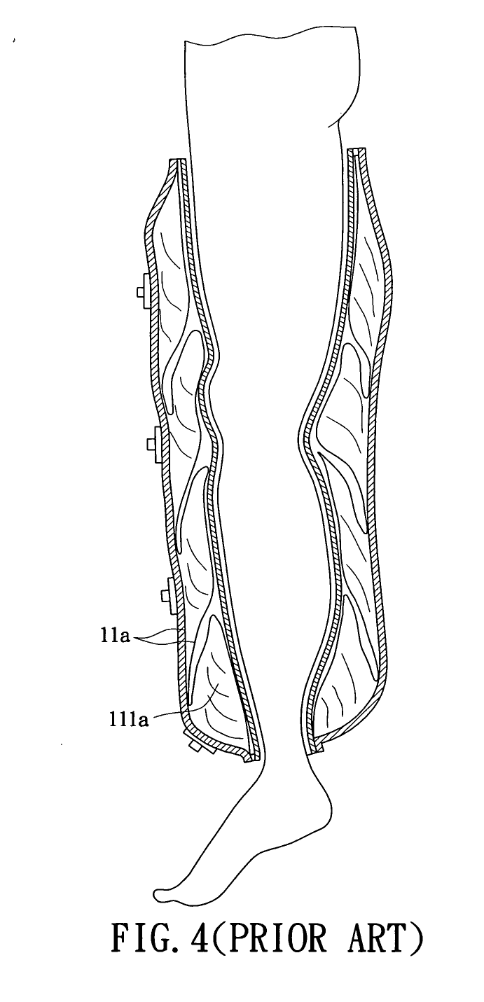

### DETAILED DESCRIPTION OF THE PREFERRED EMBODIMENTS

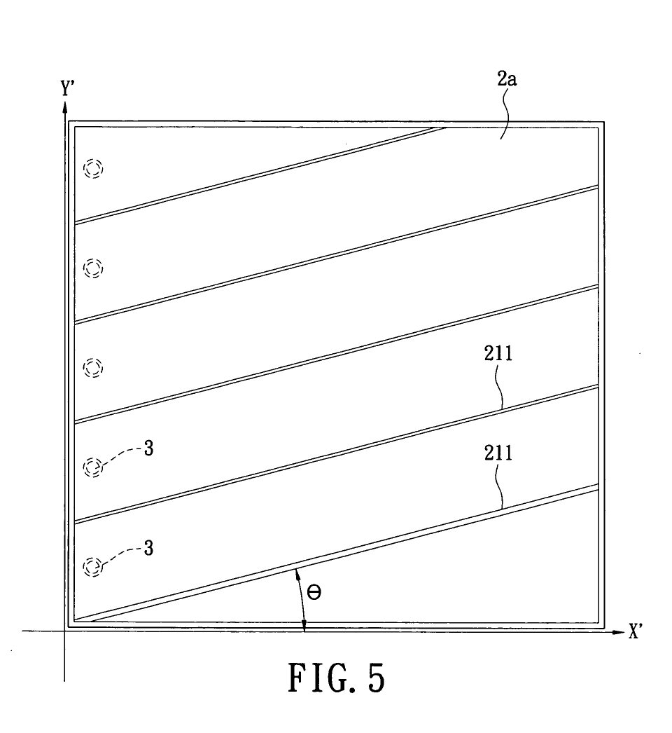

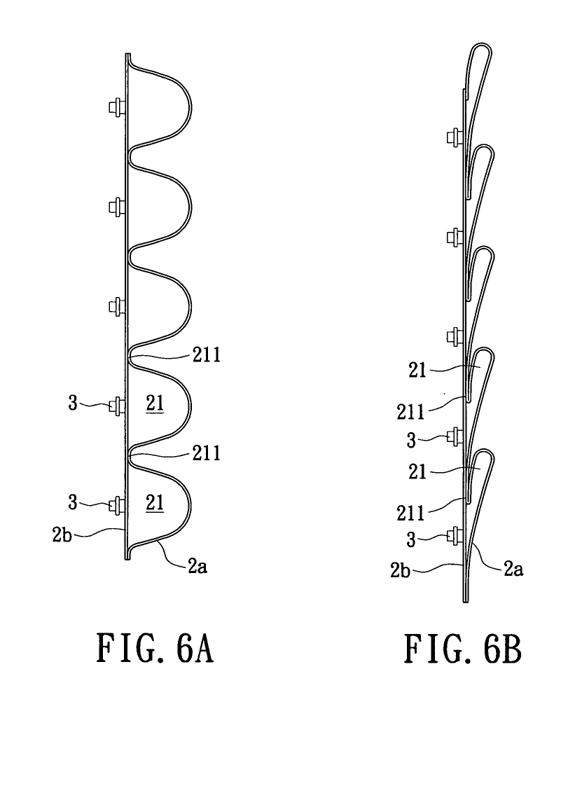

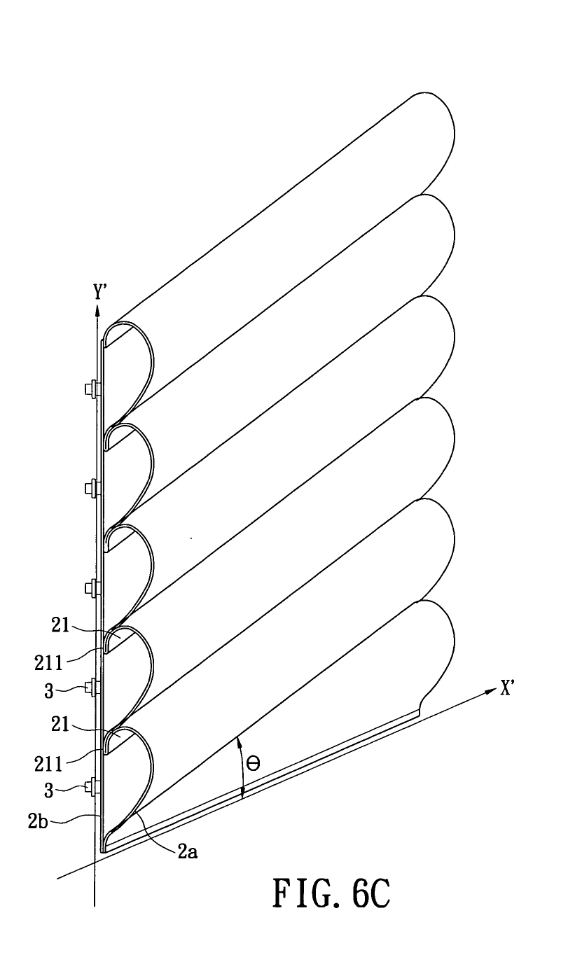

First, please refer to FIG. 5, FIG. 6A, and FIG. 6B, which shows a compression device for medical treatment in accordance with the present invention, wherein the device includes an upper colloid sheet 2a, a lower colloid sheet 2b, and a plurality of gas ports 3.

The upper colloid sheet 2a is stacked with the lower colloid sheet 2b and welded, so as to form a plurality of isolated cells 21 with welded walls 211 positioned in parallel, wherein each cell 21 is respectively connected to a corresponding gas port 3, and the gas ports 3 on each cell 21 are located on the same side. As shown by the aforementioned figures, the upper colloid sheet 2a and the lower colloid sheet 2b have an x-axis direction X′ and a y-axis direction Y′ defined, and the welded walls 211 that neighbor each cell 21 extend diagonally at an angle θ that is between the x-axis direction X′ and the y-axis direction Y′, and the welded walls 211 extend from one edge of the upper colloid sheet 2a and the lower colloid sheet 2b to another edge of the upper colloid sheet 2a and the lower colloid sheet 2b. In the present embodiment, the welded walls 211 are formed in a diagonal direction.

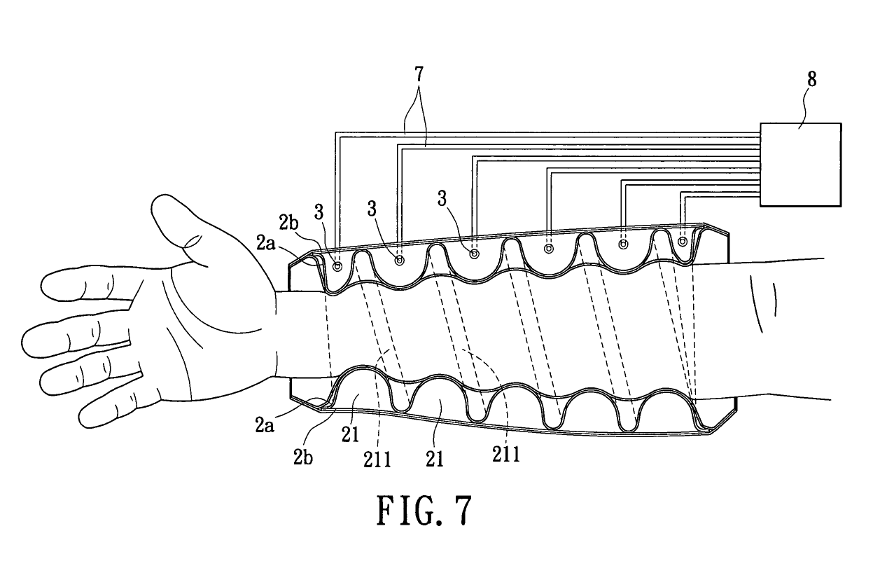

As aforementioned, please view in conjunction with FIG. 7. The present invention may be wrapped around the extremities of a human body. The figure shows as an example the wrapping around an arm of a human; when each gas port 3 of the cells 21 is attached to a gas tube 7, the cells 21 may be inflated via an air pump 8, and when gas is being filled, the cell 21 that is furthest away from the heart is filled first. After the cells 21 are filled with gas, they may compress the extremities of the human body. The present invention designed the cells 21 to expand diagonally, so that while performing compression not only an axial pressure is generated, but an oblique radial force is also generated, which results in an effect of pressing laterally and upwardly upon the compressed area. Thereby compression from two directions is achieved, which increases the effect of the compression and increases the medical benefit.

In the present invention, the aforementioned angle θ may be between the ±x-axis direction X′ and the ±y-axis direction Y′ and ranges from 15 degree to 75 degree; in other words, the angle θ may be within the four quadrants defined by the x-axis and the y-axis and range from 15 degree to 75 degree. Furthermore, the material of the upper colloid sheet 2a and the lower colloid sheet 2b may be a commonly used material such as thermoplastic polyurethane (TPU), but the material of the present invention is not limited to this particular embodiment; then the upper colloid sheet 2a and the lower colloid sheet 2b may be welded by such methods as high frequency waves, hot weld, or ultrasonic, so as to form a plurality of cells 21 with welded walls 211.

As shown in FIG. 6A, the upper colloid sheet 2a and the lower colloid sheet 2b may be directly stacked and then through high frequency waves be directly welded to form welded walls 211. On the other hand, as shown by FIG. 6B, the upper colloid sheet 2a may be folded continuously to form the shape of diagonal cells then be fitted on top of the lower colloid sheet 2b; thereby two neighboring cells 21 that has been folded forms an overlapping line for the two colloid sheets 2a, 2b, then after being welded by high frequency waves, the welded walls 211 are formed; therein, some parts of the two colloid sheets 2a, 2b are not welded via high frequency waves and did not experience the welding effect, therefore these parts are not welded together. The end result is that one cell 21 from two of the neighboring cells 21 may partially cross over another cell 21, thus after being filled with air the compression and oblique radial force effect for the cells 21 are increased.

The upper colloid sheet 2a may also be as shown in FIG. 6C, wherein the lateral length of the upper colloid sheet 2a is longer than its longitudinal length, the upper colloid sheet 2a may be arc-shaped and may be fitted on top of the lower colloid sheet 2b, so as to form a plurality of cells 21 through being welded via high frequency waves, thereby one cell 21 from two of the neighboring cells 21 may partially cross over another cell 21, which generates the effect of increasing the compression pressure of the cell 21 and generating an oblique radial force after being filled with gas or air.

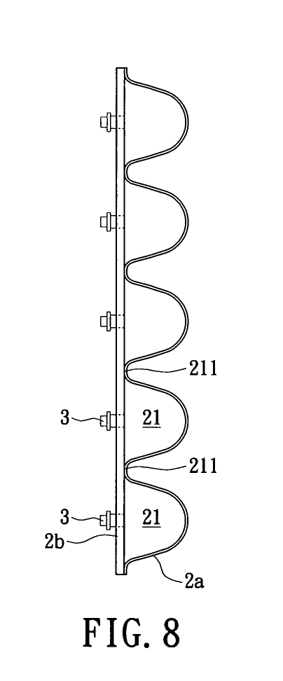

Please refer to FIG. 8, in the present embodiment, the upper colloid sheet 2a is selected from soft thermoplastic material, the lower colloid sheet 2b is selected from hard thermoplastic material, the hardness different between the two colloid sheets is greater than 10A. Therein, the upper colloid sheet 2a may be made of material with hardness degree of TPU30A; the lower colloid sheet 2b may be made of material with hardness degree of TPU85A, so that after the cells 21 has been filled with gas or air, due to the fact that the hardness specification between the upper colloid sheet 2a and the lower colloid sheet 2b are different, so that the cells 21 then expands via the expansion of the upper colloid sheet 2a. In other words the cells 21 only expand in the direction of the upper colloid sheet 2a.

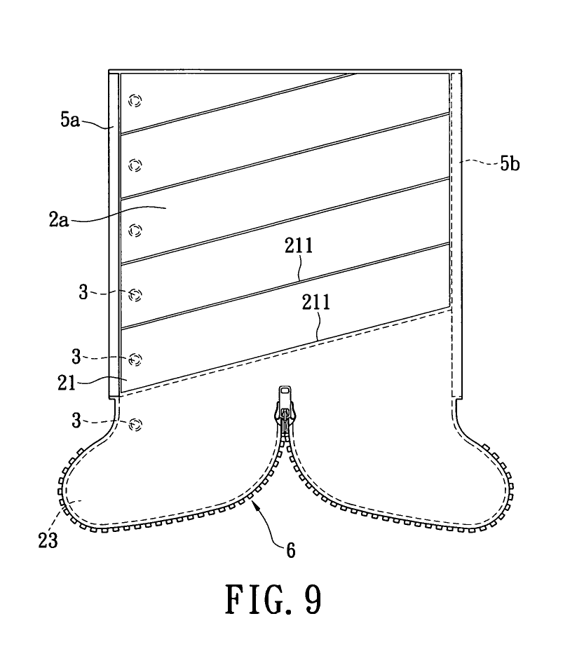

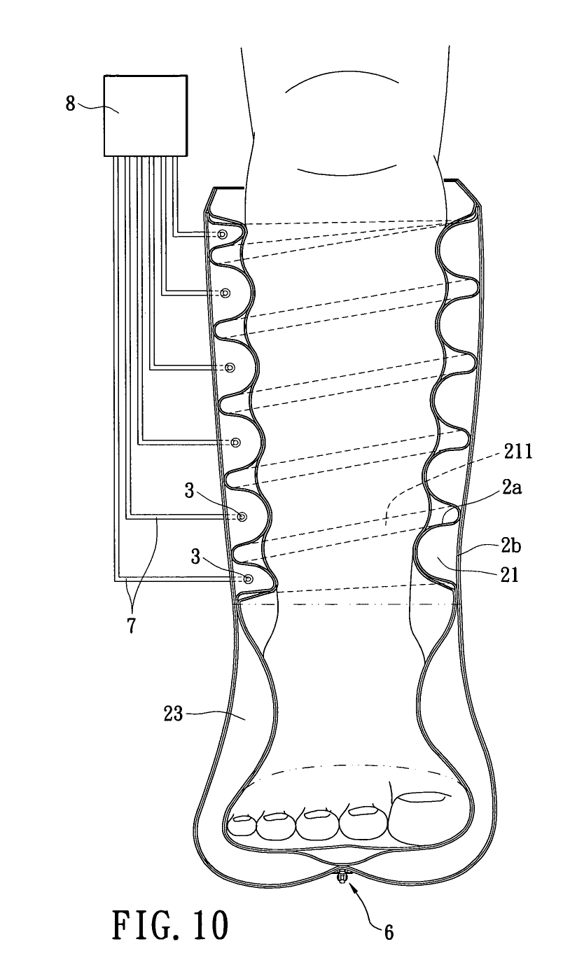

As shown in FIG. 9 and FIG. 10, in order to make the present invention be applicable to different locations on the extremities of the human body, in the present embodiment, the upper colloid sheet 2a and the lower colloid sheet 2b further form at least one auxiliary cell 23 with welded walls 211. Therein, the specific number of the auxiliary cell 23 is not limited, but all of the auxiliary cell 23 should be aligned to one side of the cells 21, furthermore each of the auxiliary cells 23 is connected to a gas port 3. The present embodiment may be used to wrap around the thenar and the lower leg, whereby the plurality of cells 21 may compress the calf, and the auxiliary cells 23 may compress the sole of the feet.

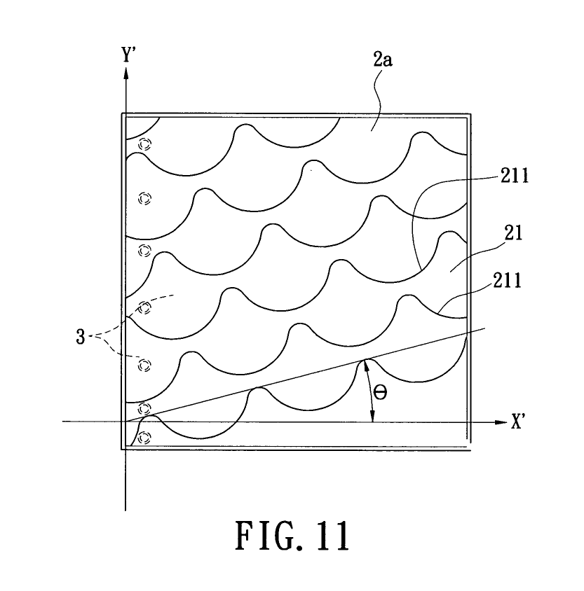

As shown in FIG. 11, the welded walls 211 that neighbor the cells 21 may be designed according to different variations. In the present embodiment, the welded walls 211 are formed in a continuous wave shape in a diagonal direction, such as a diagonal direction according to the afore described angle θ; furthermore a wave peak of one welded wall 211 from two of the neighboring welded walls 211 corresponds to a wave trough of another welded wall 211. Thereby, the effect of having a plurality of spherical shaped air chambers within a single cell 21 is achieved; so that once an air chamber has been filled with gas or air into a spherical shaped air chamber, the next air chamber may then be filled with gas or air, so as to achieve to function of gradual stage by stage pressure increase for compression, thus achieve the effect of elevating compression pressure.

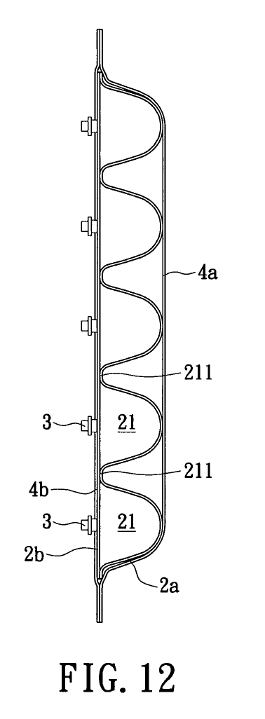

As shown in FIG. 12, in the present invention, the compression device including the upper colloid sheet 2a and the lower colloid sheet 2b may further be covered with two decoration sheets 4a, 4b that are respectively formed in a top and bottom combination. Therein, the decoration sheet 4b has a hole that corresponds to one of the gas ports 3, so that the gas port 3 may penetrate through the decoration sheet 4b, and thereby the gas port 3 may be connected to a gas tube 7. Thereby, through the decoration sheet 4a, 4b the present invention achieves the object of protecting the two colloid sheets and increasing aesthetic value.

Furthermore, please refer to FIG. 9 once again, wherein the edges of the upper colloid sheet 2a and the lower colloid sheet (not shown) may be fitted with at least a set of fixing pieces 5a, 5b, wherein the set of fixing pieces 5a, 5b may be Velcro. As shown in FIG. 9, the fixing piece 5a is fitted at the left edge of the upper colloid sheet 2a, the fixing piece 5b is fitted at the right edge of the lower colloid sheet 2b, thereby allowing the present invention to be wrapped around the limbs of a human body then to be fixed to one of the limbs. However, the fixing piece 5a, 5b is not limited to being fitted on the upper colloid sheet 2a and the lower colloid sheet 2b; the fixing pieces 5a, 5b can also be correspondingly fitted on the two edges of the aforementioned decoration sheet 4a, 4b so as to achieve similar fixing effect. Furthermore as shown in FIG. 9 and FIG. 10, when an auxiliary cell 23 has been formed, then the surrounding area of the auxiliary cell 23 may be fitted with a zipper structure 6. Therein, the zipper structure 6 is for fixing the present invention into position, so that when the zipper structure 6 has been zipped up then the auxiliary cell 23 may be fixed and wrapped around the sole of the feet of a human body.

As per aforementioned, the present invention has the following efficacy:

1. The upper colloid sheet and the lower colloid sheet forms a plurality of cells in the diagonal direction, so as to supply an oblique radial force along with regular axial pressure force when providing compression, and thereby achieves compression from two directions and so increases the benefit for medical treatment.

2. Per the aforementioned design, the position of the gas ports may be set on the same side, thereby prevent disorderly and confused piping when attaching the gas tubes. Thus, the gas tubes maybe directly attached to the gas ports prior to being wrapped on an extremity, and reducing the preparation time of the medical personals, thus reducing the operation time required when working with a patient.

3. While wrapping, the present invention wraps around an extremity of a human body in one wrap, thereby the preparation time is reduced, furthermore the slope of cells are equal, thereby the pressure when applying compression is equalized.

The aforementioned descriptions represent merely the preferred embodiment of the present invention, without any intention to limit the scope of the present invention thereto. Various equivalent changes, alternations, or modifications based on the claims of present invention are all consequently viewed as being embraced by the scope of the present invention.

What is claimed is:

1. A compression device for medical treatment, comprising an upper colloid sheet, a lower colloid sheet, and a plurality of gas ports, wherein the upper colloid sheet is stacked and welded with the lower colloid sheet, so as to form a plurality of isolated cells with welded walls, and the cells respectively correspond to the gas ports, the upper colloid sheet and the lower colloid sheet have an x-axis direction and a y-axis direction defined, and the welded walls that neighbor each cell extend diagonally along an angle that is measured from the x-axis in direction towards the y-axis, so that the welded walls extend from one edge of the upper colloid sheet and the lower colloid sheet to another edge of the upper colloid sheet and the lower colloid sheet.

2. The compression device for medical treatment according to claim 1, wherein the angle is between any one of the four quadrants defined by the x-axis and the y-axis and ranges from 15 degree to 75 degree of the quadrant.

3. The compression device for medical treatment according to claim 1, wherein the upper colloid sheet is a soft thermoplastic material and the lower colloid sheet is a hard thermoplastic material.

4. The compression device for medical treatment according to claim 3, wherein the outer surface of the upper colloid-sheet and the lower colloid sheet is further covered with two decoration sheets that are respectively formed in a top and bottom combination, and the edges of the two decoration sheets are fitted with fixing pieces.

5. The compression device for medical treatment according to claim 3, wherein the upper colloid sheet and the lower colloid sheet further form at least one auxiliary cell with welded walls, the edges corresponding to the upper colloid sheet and to the lower colloid sheet are fitted with at least a fixing piece, the auxiliary cell is located at one side of the cells, and the auxiliary cell connects to a gas port.

6. The compression device for medical treatment according to claim 3, wherein the two edges of the upper colloid sheet and the lower colloid sheet are fitted with at least a set of fixing pieces.

7. The compression device for medical treatment according to claim 1, wherein one cell from two of the neighboring cells may partially cross over another cell.

8. The compression device for medical treatment according to claim 7, wherein the outer surface of the upper colloid sheet and the lower colloid sheet is further covered with two decoration sheets that are respectively formed in a top and bottom combination, and the edges of the two decoration sheets are fitted with fixing pieces.

9. The compression device for medical treatment according to claim 7, wherein the upper colloid sheet and the lower colloid sheet further form at least one auxiliary cell with welded walls, the edges of the upper colloid sheet and the lower colloid sheet are fitted with at least a fixing piece, the auxiliary cell is located at one side of the cells, and the auxiliary cell connects to a gas port.

10. The compression device for medical treatment according to claim 7, wherein the two edges of the upper colloid sheet and the lower colloid sheet are fitted with at least a set of fixing pieces.

11. The compression device for medical treatment according to claim 1, wherein the welded walls formed by the upper colloid sheet and the lower colloid sheet are formed in a continuous wave shape in a diagonal direction, furthermore a wave peak of one welded wall from two of the neighboring welded walls corresponds to a wave trough of another welded wall.

12. The compression device for medical treatment according to claim 11, wherein the outer surface of the upper colloid sheet and the lower colloid sheet is further covered with two decoration sheets that are respectively formed in a top and bottom combination, and the edges of the two decoration sheets are fitted with fixing pieces.

13. The compression device for medical treatment according to claim 11, wherein the upper colloid sheet and the lower colloid sheet further form at least one auxiliary cell with welded walls, the edges of the upper colloid sheet and the lower colloid sheet are fitted with at least a fixing piece, the auxiliary cell is located at one side of the cells, and the auxiliary cell connects to a gas port.

14. The compression device for medical treatment according to claim 11, wherein the two edges of the upper colloid sheet and the lower colloid sheet are fitted with at least a set of fixing pieces.

15. The compression device for medical treatment according to claim 1, wherein the outer surface of the upper colloid sheet and the lower colloid sheet is further covered with two decoration sheets that are respectively formed in a top and bottom combination, and the edges of the two decoration sheets are fitted with fixing pieces.

16. The compression device for medical treatment according to claim 1, wherein the upper colloid sheet and the lower colloid sheet further form at least one auxiliary cell with welded walls, the edges of the upper colloid sheet and the lower colloid sheet are fitted with at least a fixing piece, the auxiliary cell is located at one side of the cells, and the auxiliary cell connects to a gas port.

17. The compression device for medical treatment according to claim 1, wherein the two edges of the upper colloid sheet and the lower colloid sheet are fitted with at least a set of fixing pieces.
